(19) United States
(12) Patent Application Publication
(10) Pub. No.: US 2007/0001469 A1
(43) Pub. Date: Jan. 4, 2007

(54) RETRACTABLE STRIKE FOR PANIC LOCKS

(76) Inventor: Aimone BALBO DI VINADIO, Torino (IT)

Correspondence Address: William B. Patterson;PATTERSON & SHERIDAN, L.L.P., Suite 1500, 3040 Post Oak Blvd., Houston, TX, 77056, US

(21) Appl. No.: 11/421,954

(22) Filed: Jun. 2, 2006

(30) Foreign Application Priority Data
Jul. 1, 2005 (EP) 05425474.3

(51) Int. Cl. E05B 15/02

(52) U.S. Cl. 292/341.15

(57) ABSTRACT

Retractable strike for panic locks comprising a body provided with openings for its fastening on the secondary wing of a two-wing door and a retaining element borne by the body and able to co-operate with a spring latch of a panic lock. The body has a cavity within which is mounted the retaining element. The retaining element is movable within said cavity between an extracted position and a recessed position. An elastic element is provided between the body and the retaining element to thrust the retaining element elastically towards the extracted position.

### CROSS-REFERENCE TO RELATED APPLICATIONS

This application claims benefit of European patent application number 05425474.3, filed Jul. 1, 2005, which is herein incorporated by reference.

### BACKGROUND OF THE INVENTION

1. Field of the Invention

The present invention relates to a strike for panic locks.

The strike is an element that is mounted on door frames to receive a movable closure element of a lock mounted on the openable wing.

The present invention was developed in particular in view of its application on doors with two wings able to be opened outwards and provided with a panic-proof opening system (FIG. 6). In these application, on the first wing, called primary wing, is mounted a lock with panic-proof control fitted with a spring latch that, by means of an actuating bar, is moved from an extracted position to a retracted position. The other openable wing, called secondary wing, is also provided with a panic-proof lock with upper and lower closure points. On the secondary wing is mounted a strike which co-operates with the spring latch of the panic-proof lock of the primary wing.

2. Description of the Related Art

In this type of applications, when the secondary wing is opened by means of the actuating bar of the panic-proof lock with upper and lower closure points without actuating the bar of the lock mounted on the primary wing, the simultaneous opening of the two wings is achieved, with consequent jams between the strike and the spring latch. Said jams cause strong stresses and damages to the hinges of the openable wings (the narrower the wings, the more extensive the jam). The jams between the spring latch and the strike can also cause the displacement of the strike with respect to its original position, which changes the conditions of closure of the wings.

### SUMMARY OF THE INVENTION

The object of the present invention is to provide a strike for panic lock that overcomes the aforesaid problems.

According to the present invention, said object is achieved by a strike for panic locks having the characteristics set out in the claims.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of a strike according to the present invention,

FIG. 2 is an exploded perspective view of the strike of FIG. 1,

FIGS. 3, 4 and 5 are sections respectively along the lines III-III, IV-IV and V-V of FIG. 1,

FIG. 3a is a section according to the line III-III of FIG. 1 with the strike element in retracted position,

FIG. 6 is a front elevation view of a door with two openable wings using a strike according to the present invention,

FIG. 7 is an enlarged scale perspective view of the part indicated by the arrow VII in FIG. 6, and

FIG. 8 is a view similar to FIG. 7, showing the strike according to the invention in retracted position during the simultaneous opening of the wings.

### DETAILED DESCRIPTION

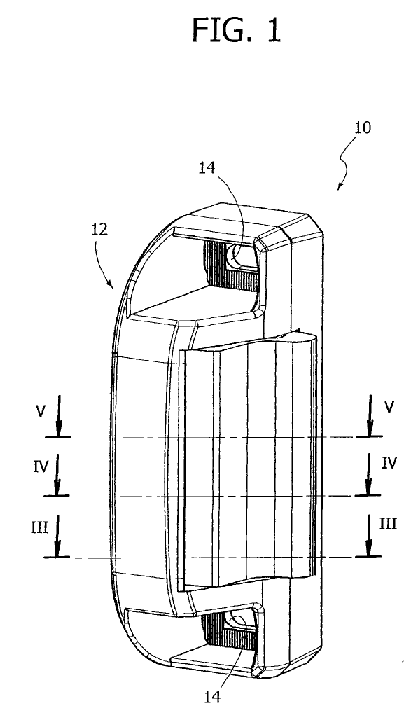

With reference to FIG. 1, the number 10 designates a retractable strike according to the present invention, to be used together with a panic lock (not shown in FIG. 1) in the case of doors with two wings. The strike 10 is fastened to the upright of the secondary wing, openable outward, of a two-wing door. The strike 10 comprises a monolithic body 12 made of a metal alloy, provided with openings 14 for its fastening to the upright of the wing.

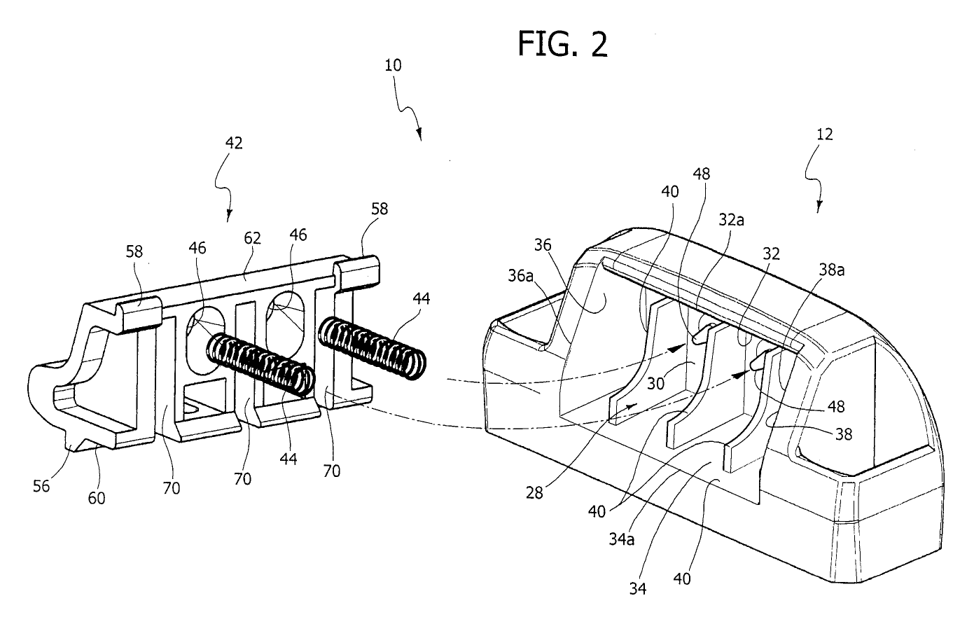

With reference to FIGS. 2-4, the support body 12 of the strike 10 has a cavity 28 open on one side. The cavity 28 is defined by a bottom wall 30, by a first pair of lateral walls 32, 34 and by a second pair of lateral walls 36, 38. The outer sides of the lateral walls 32, 34, 36 and 38, respectively designated 32a, 34a, 36a and 38a define the edge of the opening of the cavity 28.

Inside the cavity 28 are provided guide elements 40, preferably formed integrally with the body 12. Each of the guide elements 40 is constituted by a wall that extends orthogonally to the bottom wall 30 and parallel to the lateral walls 36, 38. The guide elements 40 are distanced from each other in an orthogonal direction to the lateral walls 36, 38. The example illustrated in FIG. 2 provides three guide elements 40 but their number may vary according to the applications, e.g. according to the dimensions of the body 12 and of the cavity 28.

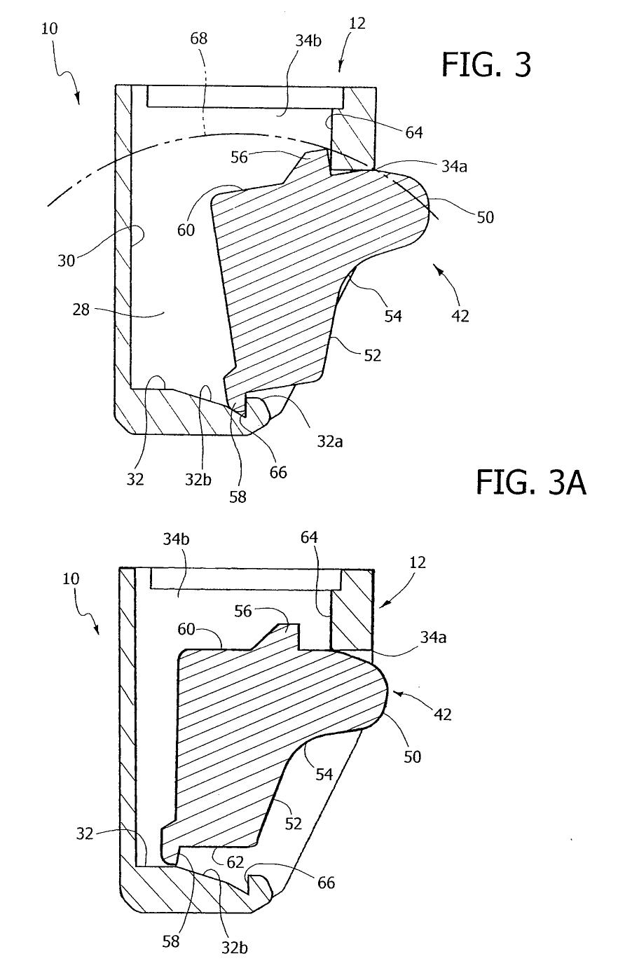

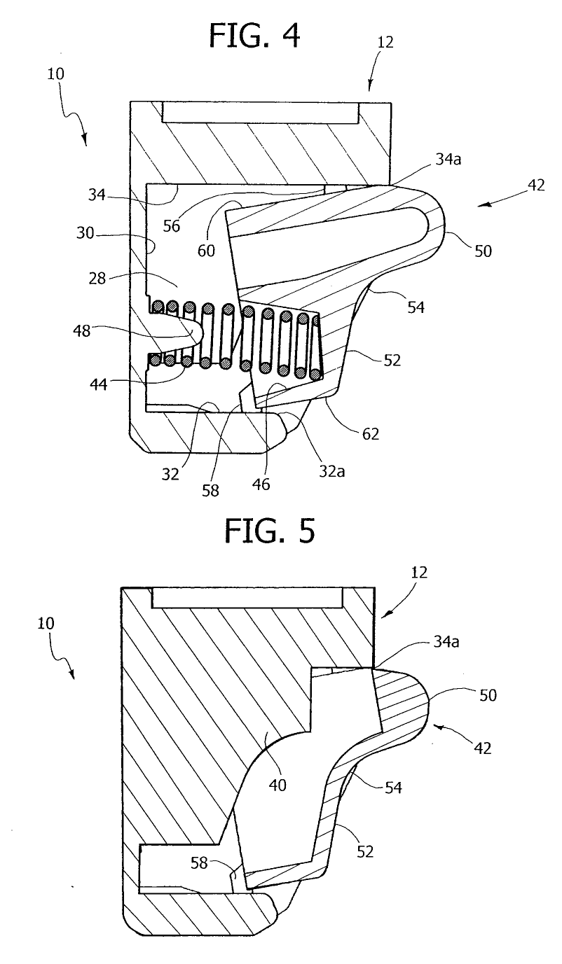

With reference to FIGS. 2-4, the strike 10 according to the present invention comprises a retaining element 42 which is separate from and independent of the support body 12. The retaining element 42 is preferably constituted by a monolithic body made of metallic alloy. The retaining element 42 is inserted in the cavity 28 and it is movable between an extracted position shown in FIGS. 3, 4 and 5 and a retracted position shown in FIG. 3a. Elastic means in compression are interposed between the body 12 and the retaining element 42 and they elastically thrust the retaining element 42 towards its extracted position. In the example shown in the figures, the elastic means are constituted by two helical springs in compression 44, each of which has a first end inserted in a cavity 46 of the retaining element 42 and a second end into which is inserted a projection 48 that extends from the bottom wall 30 of the body 12.

As shown in particular in FIGS. 3, 4 and 5 in the extracted position the retaining element 42 has an outer portion and an inner portion, which extend respectively outside and inside the cavity 28. The outer portion of the retaining element 42 has a locking surface 50 with a rounded shape and a disengagement surface 52 that is displaced inwards relative to the locking surface 50. The disengagement surface can, for example, have a flat shape as shown in FIGS. 3, 4 and 5. Between the disengagement surface 52 and the locking surface 50 is provided a rounded union surface 54.

The inner portion of the retaining element 42 comprises first and second arresting formations 56, 58. Each arresting formation 56, 58 comprises a pair of teeth that project from respective flanks 60, 62 of the retaining element 42. As shown in FIG. 2, the teeth 56, 58 are situated at opposite ends of the respective flanks 60, 62.

With reference in particular to FIGS. 3 and 4, the lateral wall 34 of the body 12 has a recessed area 34b at the arresting formations 56, in such a way as to form a front abutment surface 64 against which abuts each tooth 56 in the extracted position of the retaining element 42.

Again with reference to FIG. 3, the lateral surface 32 of the body 12 has, at each tooth 58, an inclined surface 32b which ends with a front shoulder 66 against which bears each tooth 58 in the extracted position of the retaining element 42.

With reference to FIG. 4, the elastic elements 44 are positioned at the disengagement surface 52. Hence, the force produced by each element 44 is directed towards the disengagement surface 52 and it has a certain arm with respect to the locking surface 50.

When the retaining element 42 is in the extracted position shown in FIGS. 3, 4 and 5, an external force applied on the locking surface 50 in any point of this surface and with any direction would tend to cause the retaining element 42 to rotate inwards along a circumference arc designated by the number 68 in FIG. 3, having its centre at the area of contact between the tooth 58 and the front abutment 66. However, the retaining element 42 cannot move inwards because the retaining element 42 comes in contact with the edge 34a. This contact prevents an inwards motion of the retaining element 42 (irreversibility). Therefore, the retaining element 42 is stably fixed with respect to the body 12 when the force or the resultant of external forces acting on the retaining element 42 is directed on the locking surface 50.

When instead an external force is applied on the disengagement surface 52 (effect which is manifested by operating the bar of the panic lock mounted on the secondary wing and subsequently pushing the wing outwards causing the simultaneous opening of the two wings), the retaining element 42 rotates inwards with its fulcrum on the contact area between the teeth 56 and the front abutment 64. The teeth 58 slide along the inclined surface 32b and there is no contact between the side 62 of the retaining element 42 and the edge 32a of the body 12. Therefore, when the external force or the resultant of the external forces applied to the retaining element 42 is directed on the disengagement surface 52, the retaining element 42 moves inwards compressing the elastic elements 44 and assumes the retracted position shown in FIG. 3a.

With reference to FIG. 2, the retaining element 42 is provided with grooves 70 into which are inserted the guide elements 40 provided inside the cavity 28 of the body 12. Therefore, the inward movement of the retaining element 42 relative to the body 12 is guided by the contact between the surfaces of the grooves 70 and the surfaces of the guide elements 40. The slidable guide engagement between the surfaces of the grooves 70 and the guide elements 40 assures that the movement of the retaining element 42 inwards or outwards takes place without jams.

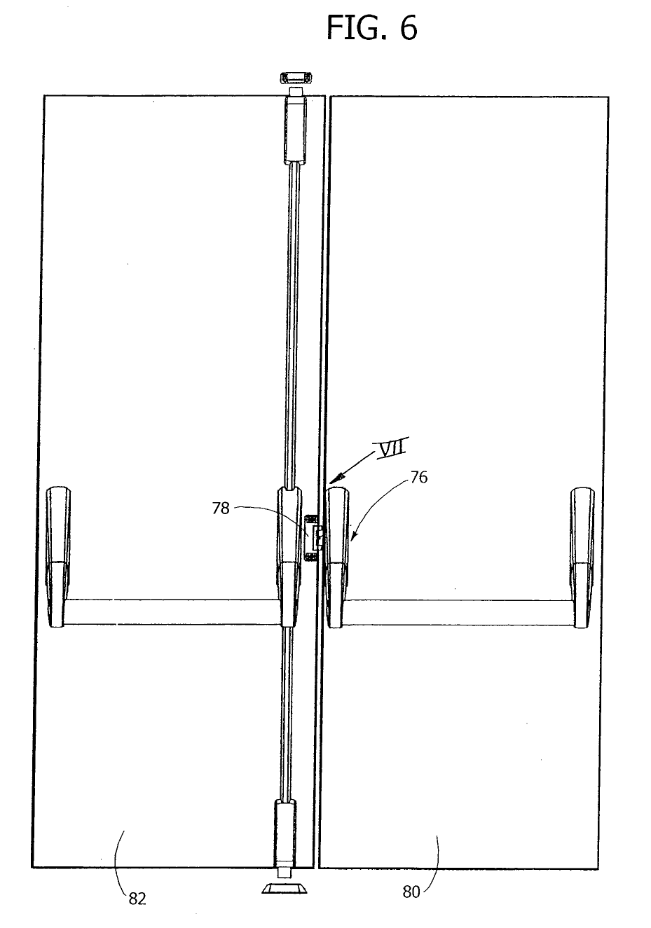

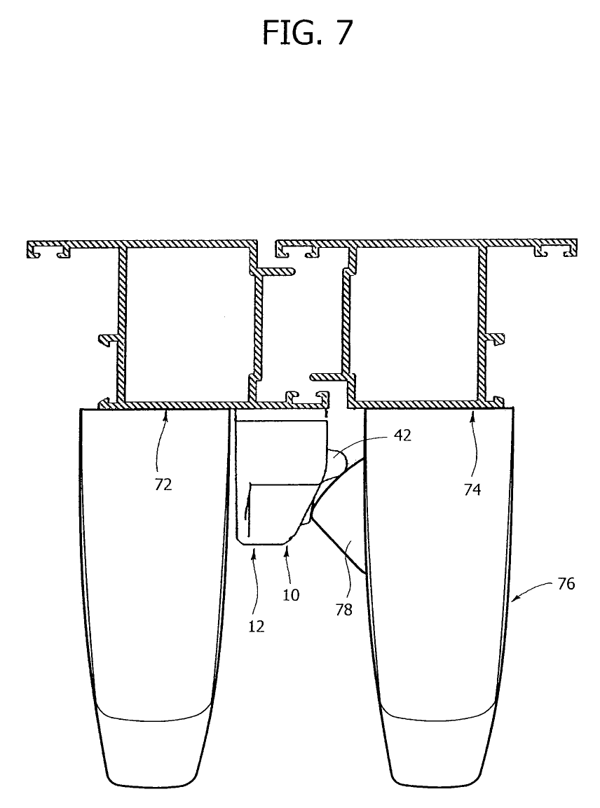

FIGS. 6, 7 and 8 show the strike 10 according to the present invention mounted on the upright 72 of a secondary openable wing 82 of a two-wing door. The reference number 74 designates the upright of a primary openable wing 80, whereon is mounted a panic lock 76 having a spring latch 78 which co-operates with the retaining element 42 of the strike 10. FIG. 7 shows the uprights 72, 74 of the wings in closed position. The retaining element 42 is fixed relative to the body 12 of the strike 10, like a traditional strike, in all conditions in which the force applied by the spring latch 78 to the retaining element 42 acts on the locking surface 50.

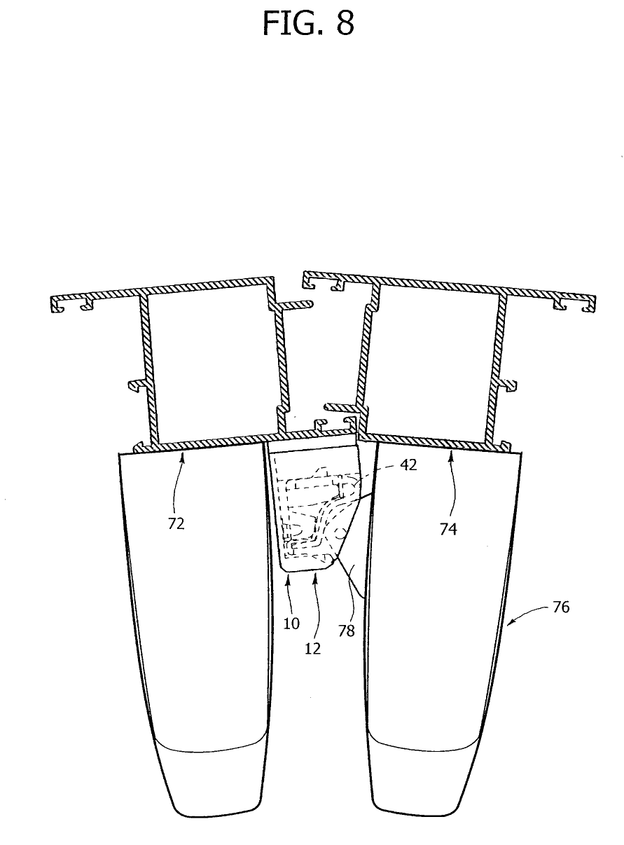

FIG. 8 shows a condition of simultaneous opening of the wings 80, 82 without the operation of the opening control of the spring latch 78, acting on the actuating bar of the panic lock mounted on the secondary wing with consequent disengagement of the upper and lower spring latches. This situation would cause a jamming of the spring latch 78 against the abutment 10 if the retaining element 42 were fixed relative to the body 12. Instead, with the solution according to the present invention, the spring latch 78 applies a force on the disengagement surface 52 of the retaining element 42. This force produces the backward motion of the retaining element 42 into the cavity 28 as shown in FIG. 8. The backward motion of the retaining element 42 allows the openable wings to open without jams and without stresses on the hinges or on the area where the strike 10 is secured to the upright 72. On the other hand, the strike 10 according to the present invention behaves as a strike with fixed retaining element in every situation in which there are no jamming problems between the spring latch and the retaining element.

While the foregoing is directed to embodiments of the present invention, other and further embodiments of the invention may be devised without departing from the basic scope thereof, and the scope thereof is determined by the claims that follow.

1. Retractable strike for panic locks comprising:
a body provided with openings for its fastening on the secondary wing of a two-wing door; and
a retaining element borne by the body and able to co-operate with a spring latch of a panic lock;
wherein the body has a cavity within which is mounted the retaining element, the retaining element being movable within said cavity between an extracted position and a recessed position, an elastic element being provided between the body and the retaining element to thrust the retaining element elastically towards the extracted position.

2. Strike as claimed in claim 1, wherein the retaining element is formed by a monolithic piece having an outer portion that, in said extracted position, extends out of the cavity, said outer portion of the retaining element having a rounded locking surface and a disengagement surface that is displaced inwards relative to the locking surface.

3. Strike as claimed in claim 2, wherein the outer portion of the retaining element comprises a union surface which extends between the locking surface and the disengagement surface.

4. Strike as claimed in claim 3, wherein the disengagement surface is substantially planar.

5. Strike as claimed in claim 4, wherein the locking surface has convex shape and the union surface has concave shape.

6. Strike as claimed in claim 1, wherein the retaining element has an inner portion that, in the extracted position, extends into the cavity of the body, the inner portion of the retaining element having first and second arresting formations which in the extracted position are thrust in contact against opposite sides of the edge of the cavity.

7. Strike as claimed in claim 6, wherein said arresting formations have the shape of teeth projecting from opposite flanks of the retaining element.

8. Strike as claimed in claim 1, wherein said elastic element is positioned to apply to the retaining element elastic forces directed towards the disengagement surface.

9. Strike as claimed in claim 2, wherein the retaining element remains motionless in the extracted position under the action of external forces whose resultant is directed on the locking surface.

10. Strike as claimed in claim 9, wherein the retaining element moves from the extracted position to the retracted position against the action of said elastic element under the action of external forces whose resultant is directed on the disengagement surface.

11. Strike as claimed in claim 1, wherein comprising a guide to guide the movement of the retaining element relative to the body.

12. Strike as claimed in claim 11, wherein said guide comprise guide walls integral with the body and extending inside the cavity and engaging corresponding grooves formed in the retaining element.
